(19) United States
(12) Patent Application Publication
(10) Pub. No.: US 2023/0325433 A1
(43) Pub. Date: Oct. 12, 2023

(54) ASSOCIATIVE SEARCHING OF MULTI-STREAM MULTIMEDIA DATA

(71) Applicant: YUJA, INC., San Jose, CA (US)

(72) Inventor: AJIT SINGH, TORONTO (CA)

(21) Appl. No.: 18/126,349

(22) Filed: Mar. 24, 2023

Related U.S. Application Data
(60) Provisional application No. 63/324,007, filed on Mar. 25, 2022.

(51) Int. Cl. G06F 16/48

(52) U.S. Cl. CPC G06F 16/489

(57) ABSTRACT

Methods of associative searching particularly suited to searching multimedia files comprising a plurality of data streams, some of the data streams being dynamic in time (e.g., a recording of a classroom lecture). Searching not only identifies given multimedia files of interest generally, but can further identify a timewise location of query matches within an identified file of interest with useful precision.

This application claims the priority benefit of U.S. Provisional Application No. 63/324,007, filed on Mar. 25, 2022, the contents of which are incorporated by reference to the fullest extent permitted.

### FIELD OF THE INVENTION

The present invention relates to improved methods of searching libraries of multimedia data yielding more precise search results with greater efficiency.

### INCORPORATION BY REFERENCE

Where extrinsic references are cited herein, their disclosures are incorporated herein by reference to the fullest extent permitted by relevant authorities, and it is the express intent of the Applicant that such subject matter, as cited, forms part of the present disclosure. Where incorporation by reference is not procedurally permitted, any and all right to incorporate information of any pertinent format from a mentioned reference into this disclosure, e.g., by revising the specification and/or drawings of this disclosure to append the textual content and/or figures of the mentioned reference, is expressly reserved.

### BACKGROUND OF THE INVENTION

The amount of electronic data (in various formats) being generated in everyday life (e.g., at work, at school, and in general personal life, etc.) is inexorably expanding, especially with advent and expansion of Internet-based technologies such as World Wide Web, streaming media services, and the like. Moreover, that data is often needed (or at least of interest) at a future time beyond a given present use. This raises important issues, not just of data storage, but also the need for workable ways of searching for desired elements of information within a continually growing universe.

Even though most electronic data generated was text-based in the early days of the Internet, the problem of efficient web page searching was still very significant.

A major early advance in efficient searching was made with inverted files and index structures. See, for example, Brin, S. and Page, L., ″The anatomy of a large-scale hypertextual Web search engine,″ Computer Networks and ISDN Systems, Volume 30, Issues 1-7, 1998, pp. 107-117; Zobel, J. and Moffat, A., ″Inverted Files for Text Search Engines,″ ACM Computing Surveys, Volume 38, No. 2, 2006, pp. 1-56; and Fox, E. et al., ″Inverted files″ in ″Information Retrieval: Data Structures and Algorithms″, ed. Frakes, W. and Baeza-Yates, R., PrenticeHall, Englewood Cliffs, NJ, 1992, Chapter 3, pp. 28-43.

More recently, researchers have refined these technologies and created a variety commercially available software tools such as, for example, Java-based Apache Lucene (see, for example, Lakhara, S. and Mishra. N., ″Desktop full-text searching based on Lucene: A review,″ 2017 IEEE International Conference on Power, Control, Signals and Instrumentation Engineering (ICPCSI), 2017, pp. 2434-2438); Apache Solr, related to but more advanced than Lucene (see, for example, Shahi, D., Apache Solr: A Practical Approach to Enterprise Search, Apress, Berkeley, 2015, and Smiley, D. et al., Apache Solr Enterprise Search System, 3rd ed., Packt Publishing Limited, 2015); and Elasticsearch (see, for example, Gormley, C. and Tong, Z., Elasticsearch: The Definitive Guide, O’Reilly Media Inc., 2015). However, most of these approaches principally target or are adapted for text data.

More recently, rapidly increasing volumes of multimedia content are being generated by a variety of sources — for example, by individuals, educational institutions, and a variety of businesses. Generally, reference to ″multimedia content″ means electronic content comprising more than one kind of content form (for example and without limitation, text, video, animation, audio, etc.). See, for example, Kasemsap, K., ″Mastering big data in the digital age,″ Effective Big Data Management and Opportunities for Implementation, IGI Global 2016, Chapter 8, pp.104-129, as well as Kaliaperumal, N. et al., ″A Content-Based Retrieval Model with Combinational Features and Indexing for Distributed Video Objects,″ International Journal of Engineering Research and Technology, Volume 13, Number 12 (2020), pp. 5142-5148.

Associative searching (sometimes referred to as content-based searching) of multimedia content is generally known but has conventionally faced several functional challenges.

First, the content of interest that is to be searched must be feasibly describable (i.e., able to be specified), which can be a complex and time-consuming exercise. Some conventional techniques for describing the target content are known. In one approach, for example, user difficulty in effectively adapting keywords to searching needs is recognized, so Search-By-Multiple-Examples (SBME) is proposed. This allows users to express their search objective(s) as a set of exemplary documents rather than as a set of keywords (i.e., ″find items similar to these examples″). Most of the studies on SBME adopt Positive Unlabeled learning (PU learning) techniques by treating the users’ provided examples (query examples) as positive set and the entire data collection as unlabeled set. However, it is inefficient to treat the entire data collection as unlabeled set, as its size can be huge. See, for example, Zhu, M. and Wu, Y.B., ″Search by multiple examples,″ Proceedings of the 7th ACM international conference on Web search and data, 2014, pp. 667-672.

Second, the description of the target content must accommodate the different kinds of data being targeted. For example, some researchers have worked on categorization and description of music data.

Pacha and Eidenberger describe optical music recognition using a universal music symbol classifier trained on a unified dataset combining over 90,000 symbols belonging to 79 classes (both handwritten and printed). Using deep learning, the classifier can achieve an accuracy that reportedly exceeds 98%. See, Pacha, A. and Eidenberger, H., ″Towards a Universal Music Symbol Classifier,″ 14th International Conference on Document Analysis and Recognition (ICDAR), 2017, pp. 35-36.

Bainbridge et al. explore methods for searching a music library for a known melody based on an actual sound sample. In other words, given an audio fragment of an unknown melody (typically played or sung by a user) as an input, a list of possible matches from a large digital library collection is returned. See, Bainbridge, D. et al., ″Searching digital music libraries,″ Information Processing and Management, Elsevier, Volume 41, Issue 1, January 2005, pp. 41-56.

Third, like the problem of workably describing the content being searched, there are challenges in articulating search queries, i.e., defining workable query specifications that are suitable for the target content. Most conventional techniques in this area can generally be put into two categories: (a) metadata-based techniques using content description provided in terms of metadata corresponding to characteristics of the type of data in question, or (b) example-based techniques whereby descriptive examples are provided that correspond with the nature of the data being searched (see, for example, Zhu and Wu, supra).

Finally, another conventional challenge is dealing with the mixture of data formats that exist, by definition, in multimedia content. While some media may be single stream, such as only audio or only video, a large portion of multimedia content comprises multiple streams of different data formats. In a simple example, video streams are often (if not usually) combined with corresponding (i.e., synchronized) audio streams for a video with sound stream.

Furthermore, content comprising more than two streams (sometime many more than two) of data is increasingly common. For example, an electronically recorded university classroom lecture can be considered as a composite 100 (as seen in FIG. 1) and may include, for example, an audio/video stream 102 (e.g., of the lecturer); a secondary video stream 104 (e.g., of a demonstrative exhibit relevant to the lecture); a screen capture or a presentation slide display stream 106; and a secondary audio stream 108.

Beyond lecture-type presentations in schools and the like, similar multi-stream multimedia content may also be generated during business meeting presentations, learning seminars, conferences, corporate training sessions, etc. This kind of multi-stream multimedia content may conventionally be stored in an active database or in a data archive, including in cloud-based storage, as is generally known in the art.

### BRIEF DESCRIPTION OF THE INVENTION

In the work disclosed herein, we focus, solely as a working example and without limitation, on multimedia files containing multiple streams of media content, such as those generated during a classroom lecture in schools, universities, and the like. However, the techniques described here can be effectively used in data produced in similar situations such as seminars, presentations, etc. For example, in a simplistic case, associative search of an audio library can be viewed as a searching a multimedia library with a single stream.

Users often need to search databases or archives of multi-stream multimedia content for the reasons like legal discovery, reuse of the content or portions thereof, legal or regulatory compliance, investigations, etc.

Searching based on content title, content production date, etc. may not be very accurate or usefully precise, and may generate a burdensome number of matches which in turn may be difficult to rank in terms of estimated relevance to conduct more detailed examination of the search results. This therefore becomes very time consuming and labor intensive. Also, as mentioned above, another problem with searching multimedia content is the difficulty in performing an associative search in terms of the target content. (See, for example, Zhu and Wu and Eidenberger, supra.) This is compounded by the fact that the content files may or may not contain multiple concurrent media streams.

Finally, a search result simply comprising a set of composite multimedia files without any ranking or other prioritization indicating relevance is not optimal because a user may have to spend significant time to actually replay each, one by one, to find out if a certain file in the search result is indeed useful. This makes finding the exact location of the target match or matches within such multi-stream multimedia files a potentially costly and time-consuming task.

### BRIEF DESCRIPTION OF THE DRAWINGS AND TABLES

The present invention will be even better understood with reference to the drawings and tables appended hereto, taken relative to the present specification herein, wherein:

FIG. 1 is a conceptual illustration of a recorded composite multimedia stream corresponding to, for example, and academic classroom lecture and comprising a plurality of data streams;

FIG. 2 generally illustrates a time-dependent representation of the various multimedia streams in FIG. 1, aligned timewise relative to the progress of the lecture referred to in FIG. 1;

FIG. 3 schematically illustrates a process of generating time stamped content-descriptive textual metadata corresponding to each multimedia stream in a composite multimedia file, and synchronizing them;

FIG. 4 is a schematic time-dependent representation of the metadata generated in the process illustrated in FIG. 3;

FIG. 5 generally corresponds to the time-dependent (or aligned) metadata in FIG. 4, and additionally illustrates a concept of partitioning the time domain into slices or segments called epochs according to the present invention;

FIGS. 6A-6D illustrate, in part, search results reflecting search query ″hits″ in respective content streams in respective multimedia files stored in a library or database, set forth as part of a working example of the present invention, whereas FIG. 6E conceptually illustrates other content streams in the library in multimedia files for which no ″hits″ were found;

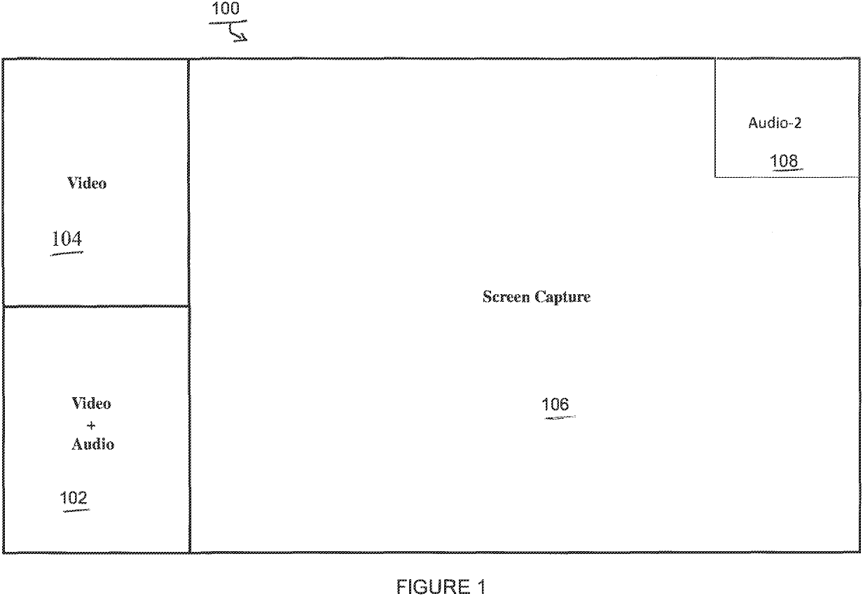

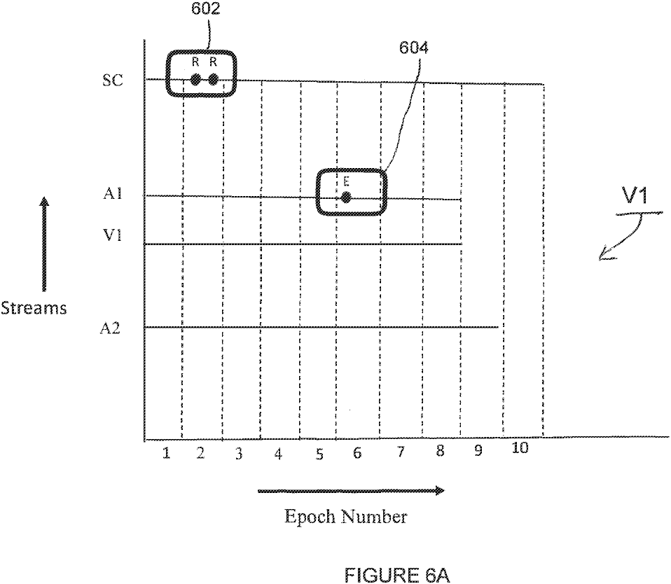

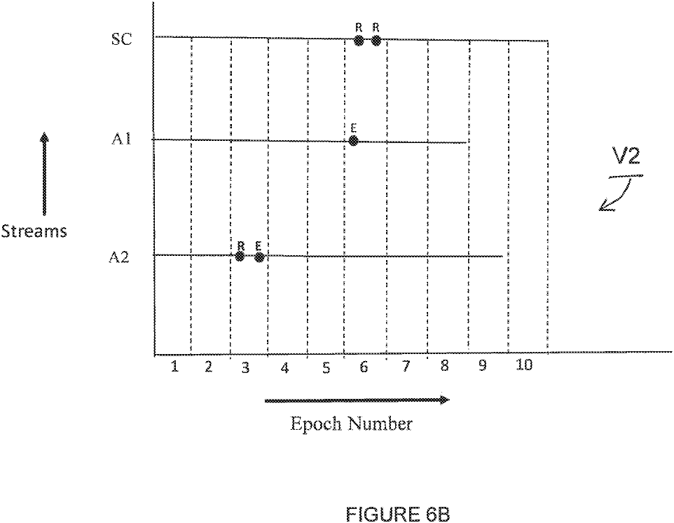

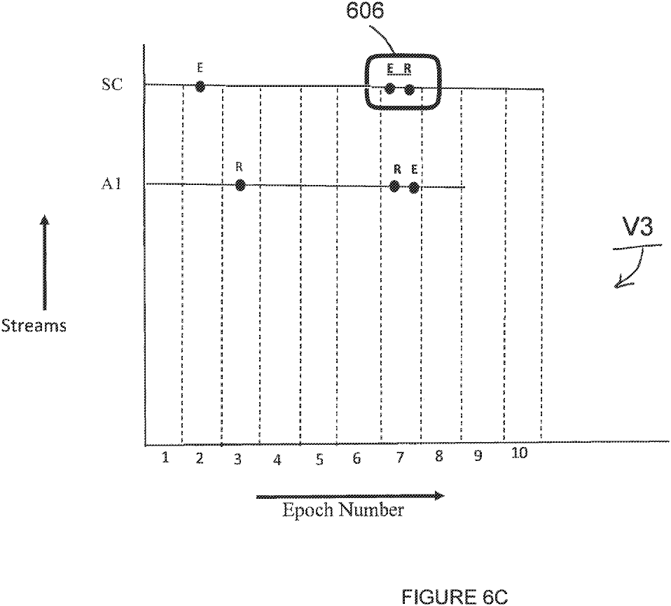

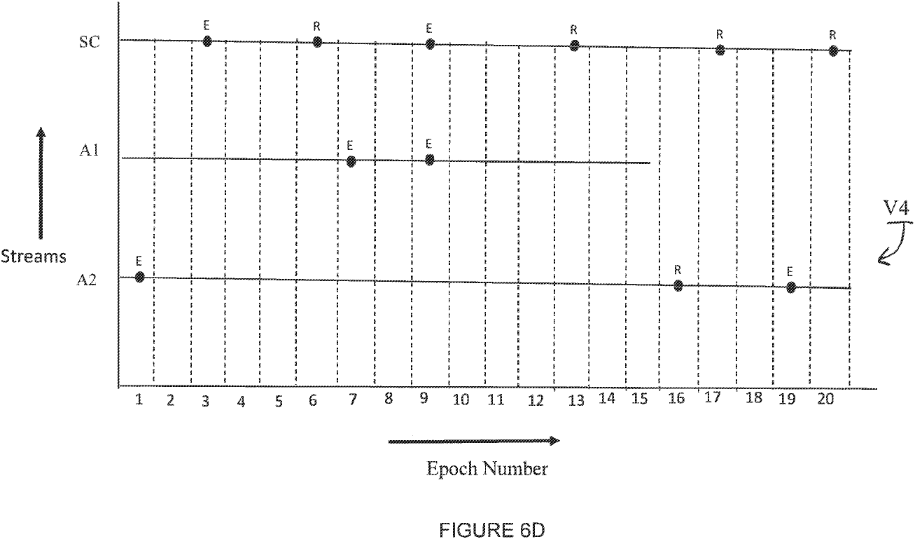

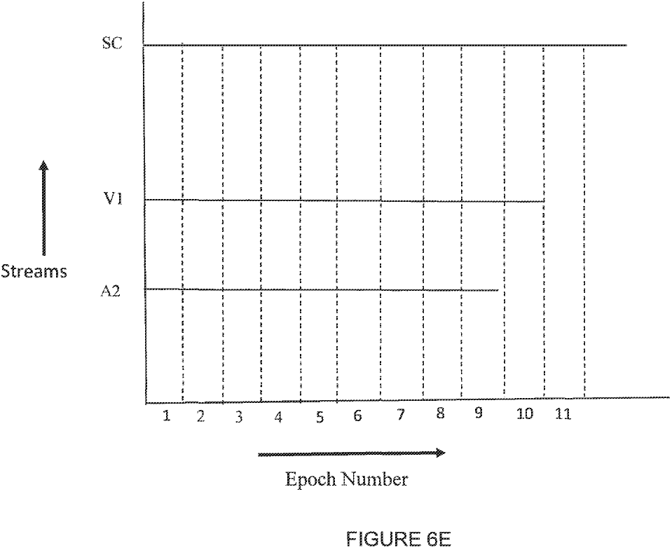

Table 1 illustrates match intensities of query matches shown in FIG. 6A relative to the epochs in which query matches were located;

Table 2 illustrates match intensities of query matches shown in FIG. 6B relative to the epochs in which query matches were located;

Table 3 illustrates match intensities of query matches shown in FIG. 6C relative to the epochs in which query matches were located;

Table 4 illustrates match intensities of query matches shown in FIG. 6D relative to the epochs in which query matches were located; and

Table 5 generally represents match intensities in a file containing no query matches, corresponding to FIG. 6E.

### DETAILED DESCRIPTION OF THE INVENTION

The present invention will be described in detail hereinbelow, along with the drawings and tables appended hereto. All parts of this disclosure are meant to be interrelated, cooperating, and taken as a unified whole to the fullest extent possible in view of the knowledge and understanding of a person of ordinary skill in this art, even in the possible absence of express linking language.

Most generally, the present invention contemplates that each media stream (audio, video, etc.) stored in a library or other data storage is to be described or otherwise characterized individually using searchable text data. Such a description/characterization could be generated automatically, for example, using relevant conventional methods (such as voice-to-text generation using voice recognition, possibly additionally enhanced using artificial intelligence methods to improve accuracy), or optical character recognition (OCR)-based screen readers that produce a searchable text equivalent of a computer screen presentation or slide presentation. Some streams such as a video scene may be described using manually input descriptive text thereby creating descriptive videos, or by other techniques used for providing descriptions of video content.

An example of AI-based OCR software of the type contemplated here is Nanonets, from Nano Net Technologies Inc. of San Francisco, California. Another relevant OCR tool is Abbyy FineReader software from Abbyy of Charlotte, NC. An example of a commercially available relevant speech-to-text convertor software is available from Verbit of New York City. Rev.com of Austin and San Francisco also makes relevant transcription software.

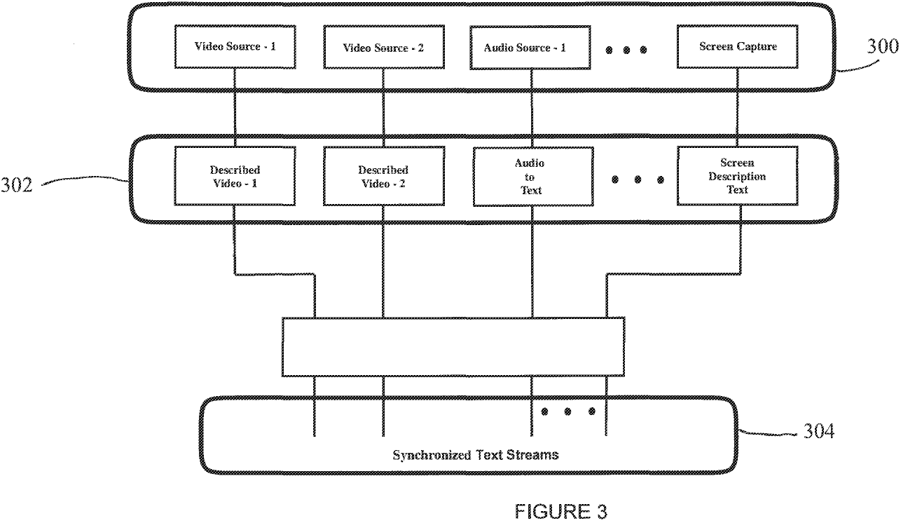

As the multimedia data is converted into corresponding text descriptions, the time when given content is generated is recorded. Thus, time is an essential parameter of the generated metadata. For our five-stream presentation discussed above, this process is generally illustrated in FIG. 3. For example, for a plurality of respective content streams 300 (e.g., video 1, video 2, audio 1, continuous screen capture, etc.), streams of corresponding descriptive text metadata 304 are generated by mechanisms or devices appropriate for that content stream at 302.

The present invention also uses ″ambient data,″ such as presentation title, slide titles, etc. Such information is by its nature not aligned or variable in correspondence with a particular instant of time, but instead exists in an ongoing manner over a span of time. For example, a lecture title is unchanging for the entire duration of the lecture, where as a given presentation slide title ″exists″ in an ongoing (albeit shorter) manner in time, for example, for as long as it is being displayed and talked about in the lecture. Ambient data can therefore be assigned a different weight during the search process. The data, both ambient data and the generated time-synchronized data, are stored using inverted-index techniques (as used in Lucene, example) along with the type of data (e.g., video, audio, OCR, etc.) in question.

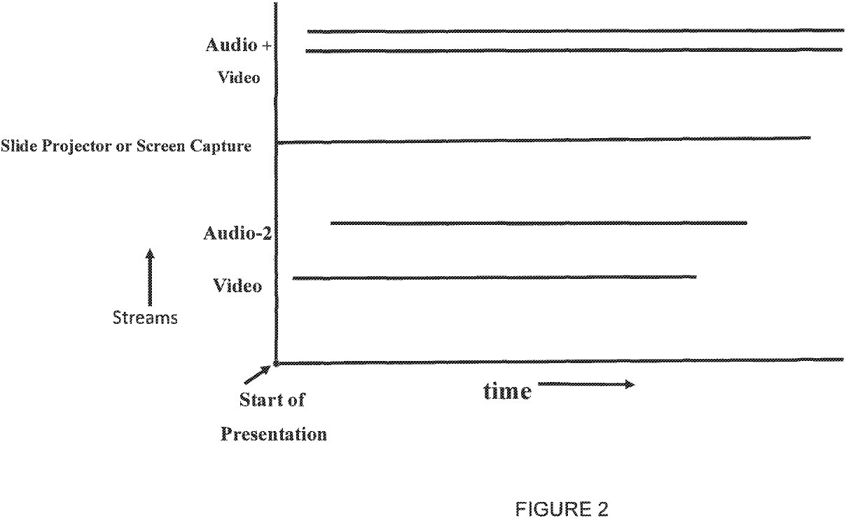

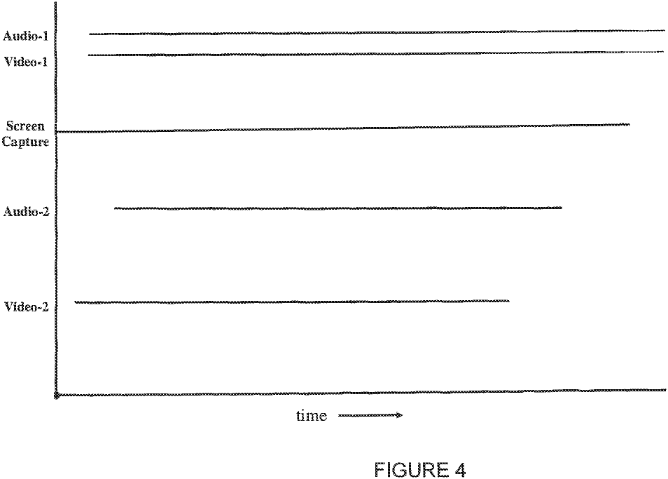

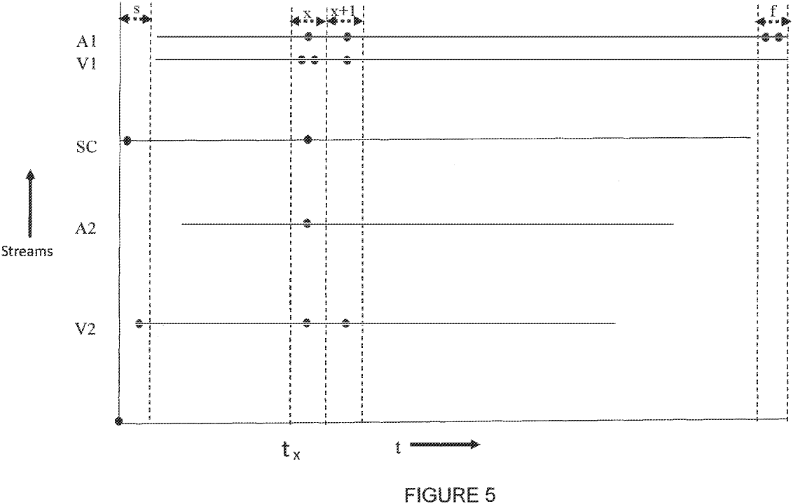

The metadata for each stream are organized along the time dimension. For our example multi-stream multimedia content file in FIG. 2, this is illustrated by way of example in FIG. 4. Unsurprisingly, the representation of metadata in FIG. 4 relative to time parallels the actual corresponding content streams in FIG. 2. The time dimension itself is partitioned into equal-sized time fragments or slices called ″epochs″ (see, for example, FIG. 5). An epoch is a configurable parameter in time units (for example, several seconds).

Most generally, a user enters a search query in the form of a text phrase or a group of text words. The system according to the present invention locates instances of keyword matches with the search query in each epoch of each of the concurrent streams of the file.

Significance values are assigned to a match occurring in a specific kind of content, based on a given weighting scheme that reflects an expectation that matches in one kind of data are indicative or suggestive of greater overall relevance to the search query than matches in other kinds of data. For example, a match with content in the presentation title may have a higher significance value (i.e., be given greater comparative weight) than the same match occurring in a slide title -the reasoning being, for example, that the presentation title may be expected to be comparatively more ″globally″ representative of the presentation content than a single given presentation slide title, which at minimum could be expected to be more narrowly descriptive of a particular slide or a particular subtopic within the presentation.

There is also an ambience value that continues or is otherwise carried throughout the scope/duration of that ambience. For example, a match in the presentation title has certain ambience value that is assumed to be present in each epoch throughout the duration of file.

To describe the workings of our algorithm, we introduce three concepts hereinbelow —Match Intensity, Match Weight, and Match Density.

Match Intensity: The match intensity (MI) of an epoch is the sum of the significance values of matches within that epoch, over all of the streams of the content. Generally, the match intensity is indicative of the comparative relevance of a given epoch (i.e., time segment) to a search query, particularly when more than one stream has query matches in the same epoch.

For example, a content file comprising N concurrent content streams, the match intensity MIₓ in a given epoch x can be specified as:

$${\text{MI}}_{\text{x}} \left(1 , \text{N}\right) = {\sum }_{i = 1}^{i = N} \text{s} \left(\text{i}\right) \qquad \text{(1)}$$

where s(i) is significance value of the matches in the iₜₕ content stream in the epoch of interest.

Match Weight: The match weight (MW) is the sum of all the match intensity values over a time period consisting of at least two consecutive epochs of the file. Generally, the match weight is indicative of the relevance of the specified time period in a given multi-stream multimedia file in terms of search query matches (as weighted via significance values) over all of the content streams of that multimedia file. Specifically, the match weight MW(x,y) in a file with N concurrent streams, between the epoch x to epoch y, inclusive, can be expressed as:

$$\text{MW} \left(\text{x, y}\right) = {\sum }_{\text{x}}^{\text{y}} {\sum }_{i = 1}^{i = N} \text{s} \left(\text{i}\right) \qquad \text{(2)}$$

Alternately, it can be expressed as:

$$\text{MW} \left(\text{x,y}\right) = {\sum }_{\text{x}}^{\text{y}} \text{MI} \left(1 , \text{N}\right) \qquad \text{(3)}$$

Match Density: Match Density (MD) is the average Match Weight over a period consisting of several consecutive epochs. The concept of match density is used in our algorithms for taking into account the length (in terms of number of epochs) of the file while ascertaining the relevance of a file for a given search. Further, the concept of match density can be utilized for locating comparative interesting portions of the file for a given search irrespective of the durations of the said portions.

Therefore, for a given time period (i.e., for a given set of consecutive epochs):

$$\text{Match} \text{} \text{Density} \text{=} \text{Match} \text{Weight} / \text{Length of the period in epochs} \text{.}$$

In other words, match density between epochs x and y is expressed as:

$$\text{MD} \left(\text{x,y}\right) = \text{MW} \left(\text{x,y}\right) / \left(\text{y} \text{−} \text{x} \text{+} \text{1}\right) \qquad \text{(4)}$$

### Example Algorithms for Searching Multi-stream Multimedia Libraries

In general, a user provides a search query that consists of two parts: (a) query parameters and (b) a search phrase.

Query parameters in a database query have a format depending on the respective query language supported by the underlying database system. For example, in a relational database, the relevant query parameters may be Structured Query Language (SQL)-based query language statements. See, for example, Date, C., ″A Guide to the SQL standard,″ 4th ed., Addison Wesley, 1997. In general, query parameters are inputs that are functionally germane or related to a search other than the search phrase itself. In one example, when searching a company server on which the files of several employees are stored, identifying a specific employee by name (to limit the search to that employee’s files) would be a query parameter. Also, parameters controlling where to search (as opposed to what to search for) could be considered query parameters.

A search phrase consists of a text string with one or more words in it. Using the query parameters supplied by the user, one can retrieve an initial set of files. Each file in the set of matching files from the database are then further examined for presence of any word(s) in the search phrase in any order.

With the foregoing as preface, the above-mentioned definitions of match intensity, match weight, and match density are used to retrieve match results for different types of queries. For illustration, three example algorithms relying on these concepts — Algorithm-1, Algorithm-2 and Algorithm-3 — are described below to illustrate how these concepts are used in practice according to the present invention. The three algorithms will first be each described generally, and then a more substantive illustrative example using them will be described thereafter.

Algorithm-1 (Find relevant files out of a plurality of files): Broadly, Algorithm-1 provides a quick identification of multi-stream multimedia files of interest having matches, where the files having matches are ranked according to likely relevance.

Algorithm-1 starts with Video Library VL (stored in a database and containing a plurality of multi-stream multimedia files), uses Query Parameters Q and Search Phrase P as inputs, and generally comprises the following steps:
1. Query the database for the video library VL and find the video files in VL that satisfy all the query parameters in Q.
2. Store the results from step 1 in a set called L.
3. Given the search phrase P, calculate the match weight over the entire duration of each video file in set L (i.e., over all the epochs of each video file in set L). This result reflects or otherwise is indicative of an extent to which words from search phrase P are present in each file in set L.
4. Calculate the match density for each video file in set L to take into account the length of each file (in epochs).
5. Sort the video files in set L in descending order of respective match densities in correspondence with their anticipated relative relevance. The result is set forth in terms of (MD, filename).

As a result, we obtain a sorted list of video files in L in descending order of expected relevance to the initial search (based on relative match densities).

Algorithm-2 (Locate query matches in a given file): Broadly, Algorithm-2 obtains, for a given search phrase, the most relevant query matches and their locations within a video file between two given epochs.

By way of example, a given video file V is searched using a search phrase S between start epoch M and end epoch N, where each epoch is of time length t.

1. Prepare video file V for analysis, using the search phrase S.
2. Divide the entire duration of the file V into a plurality of epochs each of time length t between start epoch M and end epoch N.
3. Given the search phrase S, calculate the match intensity of each epoch in the file V while also noting the time locations (i.e., the corresponding epochs) of matches.
4. Record ordered pair values (MI, Location) for file V in a set called Matches. Here, for a single given file V, the location is simply a given epoch whereas among several files Vₓ, the location is in terms of file Vₓ and epoch.
5. Sort the set Matches in descending order of match intensity to create a set of ordered pair values (MI, Location).

Accordingly, Algorithm-2 obtains not just a sorted result in terms of relevance, but it also outputs timewise locations (i.e., in terms of epochs) of the respective matches.

Algorithm-3 (Locate Match Points among Several Relevant Files): Broadly, Algorithm-3 has two parts. Given a video library VL (containing a plurality of video files), query parameters P, and search phrase SP, the algorithm provides the most relevant matches in the most relevant video files in the video library and ranks the matches in order of relevance.

Here, we start with a video library VL containing a plurality of searchable video files, using searches comprising query parameters P and a search phrase SP. The video files in the video library VL are divided into epochs of time length t.

With reference to the description of Algorithm-1 above, the first part of Algorithm-3 is the execution of Algorithm-1 based on P and SP. The result is stored as a set L including, for example, n files from VL having query matches.

In the second part of Algorithm-3, Algorithm-2 is used for each of the n files in set L, using search phrase SP, First-Epoch 1 and Last-Epoch Fₙ (where each Epoch is time length t).

This results in n (corresponding to the number of files in set L) sets of matches M₁...Mₙ in the form (MI, Location, Filename). Here, Last-Epoch Fₙ represents the final epoch for the nₜₕ file in L.

The n sets of matches M₁...Mₙ are then merged into a single global set of matches M. Set M is then sorted in descending order of match intensity to create a set of tuples (MI, Location, Filename).

Resultant combined set M therefore indicates matches throughout the files in set L, in descending order of assessed relevance, along with the time location of the matches in terms of epochs.

The concepts of match intensity, match weight, and match density are fundamental to our approach and can be used to create further algorithms based on the requirements of the search as shown in the following illustrative example.

### Example: Multi-Stream Video Library Search in a University Environment

Universities and other learning institutions now routinely record their classroom lectures in a composite multi-stream video format. Some universities even record each of their classroom lectures systematically and create libraries of the recordings.

Furthermore, third-party commercial vendors exist who provide cloud-based information storage and retrieval services to support such collections. In some cases, these vendors provide services to multiple content-generating clients, so their cloud-based storage systems could be very large, containing thousands or even millions of such composite videos.

In this environment, therefore, suppose there is a student who wants to look for lecture videos containing certain keywords in any combination of its component audio, video, screen-capture or slide presentation (e.g., Microsoft PowerPoint presentation) streams.

The student submits a search request via the user interface of the relevant video library system, sometimes referred to in the art as a Multi-Media File System (MMFS), at which time the student specifies search parameters such as University Name (recall that some systems may store content from multiple schools), Course Number or Course Title, Year, Term (e.g., spring, summer, fall), along with the search keyword(s) of interest. The search parameters may optionally narrow the search to a progressively smaller set of files - for example, for a given university entered (and possibly also a given year and or term), subsequent parameters such as course numbers/names may be limited to those offered at that university, and, as applicable, offered at the indicated time.

For example, a student is looking for the lecture video in which the professor did a review of the course material before the exam. To undertake a relevant search, the student will typically populate a MMFS user interface with relevant query parameters (for example and without limitation, one or more of University Name, Course Number, Year, and Term), and the desired search terms or phrase. Some of the query parameters such as course name and search phrase need to be specified explicitly whereas query parameters such as University Name, Year and Term may possibly be determined from the context or default values.

More specifically, the purpose of the search request may be, for example and without limitation, to: (a) find the recorded multimedia lecture(s) in a course titled “Operating Systems” in the current year and term in which the professor did the ″Exam Review″ during the lecture(s); and (b) identify the most relevant times/moments during the recorded lecture(s) where matches with ″Exam Review″ occurred. Here, University Name, Course Title, Year, Term are query parameters, and ″Exam Review″ is the search phrase, in accordance with the explanations above.

According to the present invention, the MMFS acts on the search request as follows.
1. A simple database query will initially provide a set L of videos that satisfy the query parameters University Name, Course Name, Term, Year.
2. Set L may likely have many videos, of which many or even most are likely to not have any of the words in the search phrase. Others may have one or more of the specified words in the search phrase. For the sake of simplicity, we suppose for the purposes of this example that we get four video files (V1, V2, V3, and V4) that satisfy the query parameters and that additionally contain one or more words in the search phrase, in one or more component data streams of the files.

The component data streams that appear in these files and their respective search phrase matches are shown in FIGS. 6A-6D respectively. For the sake of completeness (and comparison), remaining videos that do not contain any search query matches generally look like FIG. 6E for the purposes of this invention.
3. At this point, the Multi-Media File System (MMFS) uses the algorithms presented above to rank the four video files (V1, V2, V3, V4) in order of their relevance to the search query, and to find the exact locations (timewise) within these files in order of strength of these matches and provide overall ranking of the matches occurring in all the files.

To carry out the overall ranking, different match scenarios are assigned different weights via significance values. In one example of the present invention, the weighting scheme may look as follows:
(1) Exact Match (all terms match, in order of search phrase): 1.1
(2) All terms match (all terms match, any order): 1
(3) Partial match (less than all terms of search phrase match, any order): (1/total number of words in the search phrase) *(number of matched words).
(4) Weights for matches in different stream types: presentation slides =1; screen capture = 1; audio-stream-1: 0.75; audio-stream-2: 0.75; video-stream: 1.
(5) In our examples, if a textual video description is not present (as is frequently the case for classroom lecture videos), no metadata text will be present for the video streams. Consequently, no matches will be found in the video streams and no weighting will be assigned thereto.
(6) Ambience weight factors: match in presentation title = 2; match in slide title = 1.5.

A significance value of a given match is determined using these configuration parameters wherein query search matching is optionally case-insensitive for simplicity.

For example, as seen in FIG. 6A, the video file V1 has two occurrences of word ″REVIEW″ at 602 in the screen capture stream SC during the epoch 2 (i.e., two matches of one of the two words of the search phrase).

So, the significance value of this partial match (per occurrence) according to our configuration here is: [(1/total # of words in search phrase) x number of matched words)] x (weight by stream type)

$$\begin{matrix}= \left[\left(\frac{1}{2}\right) \times \text{1}\right] \times \text{1} \\ \text{=} \text{0} \text{.5}\end{matrix}$$

Since the match occurs twice in the same epoch, the total significance value of this match is 1.

Also in FIG. 6A, file V1 has one occurrence of ″EXAM″ at 604 in the Audio-1 stream A1 in epoch 6. As a partial match, its significance value (as shown in Table 1) is: [(1/# of words in search phrase) x number of matched words)] x weight for stream type

$$\left[\frac{1}{2} \times \text{1}\right] \times \text{0} \text{.75} \text{=} \text{0} \text{.375}$$

The duration of each video file is divided into a plurality of epochs of equal time duration t (in seconds). The time duration t is user-configurable according to the present invention. The choice of length/duration of an epoch is a compromise - shorter duration epochs lead to a more precise identification of the timewise location of a match, but that necessarily means more epochs in every file, which in turn means correspondingly more computing analysis according to the present invention. For this reason, the present invention envisions identifying the timewise locations of a query match with a reasonably useful precision that, while perhaps not pinpoint precise, is sufficiently precise to enable a searching user to avoid spending inordinate time having to review files to locate a moment of interest. For this purpose, epochs according to the present invention may usefully be, for example and without limitation, a few seconds (e.g., less than about ten seconds) to a few tens of seconds (e.g., about ten or 20 seconds long). It will be appreciated that the timewise length of a given file will have a significant effect on this choice.

FIGS. 6A-6D illustrate the plurality of data streams present in files V1, V2, V3 and V4, where ″E″ corresponds to ″EXAM″ and ″R″ corresponds to ″REVIEW″ in the search query such that, for example, an indication of ″E R″ reflects a match to ″EXAM REVIEW,″ ″R E″ indicates a match to ″REVIEW EXAM,″ ″R R″ is a match to two occurrences of ″REVIEW,″ and so on. Underlining indicates a special case of matches occurring in a slide title (see, for example, ″E R″ in epoch 7 of the screen capture SC stream of FIG. 6C.

FIGS. 6A-6D illustrate examples of query matches that occur in each stream at various points of time within the respective video files.

Finally, FIG. 6E generally represents a file in set L without any query matches.

Tables 1-4 correspond with FIGS. 6A-6D, respectively, and show the match intensities (according to the definitions and explanations above) in individual epochs in our files V1, V2, V3 and V4.

Table 5, in turn, corresponds with FIG. 6E and illustrates a file in which no search query matches are found.

Based on the definition of match weight presented earlier, by adding up all the individual match intensities in a given epoch, we get the match weights over all epochs of individual files. This is shown in the last row of each of Tables 1-4.

For example, returning to FIG. 6A and Table 1 by way of illustration, the match weight is sum of significance value 1 (for REVIEW, twice in epoch 2) plus 0.375 (for EXAM in epoch 6), or 1.375; in FIG. 6B/Table 2, the match weight is 2.125; in FIG. 6C/Table 3, the match weight is 3.275; and in FIG. 6D/Table 4 the match weight is 4.875.

By dividing the match weight by the number of epochs in the respective files, we get the match densities of each file. Accordingly, the match density for FIG. 6A/Table 1 is the match weight 1.375 divided by the ten epochs constituting the file V1, or 1.375/10, or 0.1375. Similarly, the match density for FIG. 6B/Table 2 is 0.2125; the match density for FIG. 6C/Table 3 is 0.3275; and the match density for FIG. 6D/Table 4 is 0.24375 (note that file V4 is divided into twenty epochs).

Now, we use the Algorithm-1, Algorithm-2 and Algorithm-3 presented earlier to illustrate the overall process of associative search of multi-stream multimedia files:

### Algorithm-1 - Find Relevant Files for a Given Search Phrase

For Algorithm-1 we compute the match densities of each file V1-V4 having matches. This is computed by dividing the match weight of each file by the corresponding number of epochs in that file.

The match weights of files V1-V4 are 1.375, 2.125, 3.275, and 4.875, respectively. Therefore, the corresponding match densities of files V1-V4 are 0.1375, 0.2125, 0.3275, and 0.24375, respectively.

Thus, files sorted in descending order of match density are {(0.328, V3), (0.244, V4), (0.213, V2), (0.138, V1)}.

The remaining files in the set L have no matches (as illustrated by way of example in FIG. 6E/Table 5) so those files are eliminated from further analysis according to the present invention. This improves processing efficiency by avoiding needlessly repeating analysis of ″empty″ or matchless files.

Therefore, the output of this Algorithm-1 is the set I, where

$$\text{I} \text{=} \left\{\left(0.328 , \text{V3}\right) , \left(0.244 , \text{V4}\right) , \left(0.213 , \text{V2}\right) , \left(0.138 , \text{V1}\right)\right\}$$

and we can understand that file V3 is comparatively the most interesting (i.e., most relevant) relative to the search query.

### Algorithm-2 - Locate Matching Points During a Given Period in a File

Next according to the present invention, we additionally identify timewise locations of significant match intensities over the entire duration (i.e., over all of the constituent epochs) in each of the files.

While Algorithm-1 identifies a selected set of files that are relevant to our search query, at this point we do not know the exact timewise locations within the files where the match(es) occurred. To find these match locations, we use Algorithm-2 to find locations of significant match intensities over all the epochs of the files as follows:

As described above, we first obtain the match intensities of each epoch of each of the multimedia files, V1, V2, V3 and V4. This requires adding the significance values of each of the matches in the given epoch of the given file. Tables 1-4 show the significance values for the query matches indicated in FIGS. 6A-6D. By totaling the significance values of all the streams in a given epoch, we get the match intensity of that epoch in that file.

As noted, the match intensities for the epochs in files V1-V4 are totaled on the last (bottom) row of Tables 1-4.

Then, according to the explanation of Algorithm-2 above, the sorted set MATCHES (i.e., MI, location) becomes MATCHES = {(2.40, 7, V3), (1.375, 6, V2), (1, 2, V1), (0.875, 9, V4), (0.75, 3, V2), (0.5, 2, V3), (0.5, 3, V4), (0.5, 6, V4), (0.5, 13, V4), (0.5, 17, V4), (0.5, 20, V4), (0.375, 6, V1), (0.375, 3, V3), (0.375, 1, V4), (0.375, 7, V4), (0.375, 16, V4), (0.375, 19, V4)}.

Accordingly, we can understand that most significant query result is at epoch 7 of file V3 (in FIG. 6C) which contains an exact match E R in screen capture stream SC at 606 (in a slide title per the underline notation, as explained above) and an ″all terms match″ R E in audio stream A1 at 608, resulting in the highest match intensity 2.40 as seen in Table 3.

### Algorithm-3 - Locate Matches in Relevant Files

Again, the objective with Algorithm-3 is to (a) find the files of interest according to the search query, and (b) find locations within the particular files of interest that are most relevant, relatively.

### Part 1:

By executing Algorithm-1 as shown previously, we get files of interest, and their match densities as a set I of tuples:

$$\text{I} \text{=} \left\{\left(0.328 , \text{V3}\right) , \left(0.244 , \text{V4}\right) , \left(0.213 , \text{V2}\right) , \left(0.138 , \text{V1}\right)\right\}$$

### Part 2:

Next, Algorithm-2 is executed only on the identified files of interest to get information about the exact locations of the matches within those files, expressed as a set called MATCHES, wherein

$$\begin{matrix}\text{MATCHES} \text{=} \left\{\left(2.40 , 7 , \text{V3}\right) , \left(1.375 , 6 , \text{V2}\right) , \left(1 , 2 , \text{V1}\right) , \left(0.875 , 9 , \text{V4}\right)\right) \\ , \left(0.75 , 3 , \text{V2}\right) , \left(0.5 ,\right) \\ \left(2 , \text{V3}\right) , \left(0.5 , 3 , \text{V4}\right) , \left(0.5 , 6 , \text{V4}\right) , \left(0.5 , 13 , \text{V4}\right) , \left(0.5 , 17 , \text{V4}\right) , \\ \left(0.5 , 20 , \text{V4}\right) , \left(0.375 , 6 , \text{V1}\right) , \left(0.375 ,\right) \\ \left(3 , \text{V3}\right) , \left(0.375 , 1 , \text{V4}\right) , \left(0.375 , 7 , \text{V4}\right) , \left(0.375 , 16 , \text{V4}\right) , \left(\left(0.375 , 19 , \text{V4}\right)\right\}\end{matrix}$$

Thus, given a video library and a given search query, we can find not only relevant files of interest relative to the search query but also the locations, in terms of the epoch number, of the relevant query matches, sorted in an estimated order of their relevance.

Compared to conventional approaches to associative searching, the present invention is unique in terms of identifying relative times (i.e., instances) at which a given event, moment, or other item of information is present in files being searched. This consideration of the time domain facilitates direct identification of where a desired result is located and therefore eases the user experience.

Also, conventional searching approaches do not distinguish between component media streams making up a composite multi-stream multimedia file. That is, conventionally, a multi-stream multimedia file is considered to have a query match as a whole, or not. Differently, in the present invention, component media streams are analyzed individually, and different streams are weighted differently in general, and, taking into consideration use of the time domain in the present invention, higher search relevance (i.e., significance) can be attributed to time periods when more than one component stream had relevant matches simultaneously. (See, for example, File V3 discussed above, at epoch 7.)

While the present invention is described hereinabove by way of certain examples, it should be clearly understood that the invention as contemplated can be modified while remaining within the ambit of the broad concept of the invention. Again, all features described herein can be used with other features described to the fullest extent possible, even in the absence of specific linking language to that effect.

What is claimed is:

1. A method of searching for one or more search words in at least one streaming composite media file comprising a plurality of component media streams, wherein at least some of the component media streams have different data formats from each other, the method comprising:
dividing a streaming composite media file into a plurality of time segments of equal length;
determining whether or not any of the sought-after search words are present in the streaming composite media file on a time segment-by-time segment basis;
in a time segment where one or more of the sought-after search words are present, assigning a significance value to each match in that time segment based on a closeness of the match between the one or more sought-after search words and the corresponding one or more search words located in that time segment;
totaling the significance values in each respective time segment of the streaming composite media file to obtain a match intensity value for that time segment;
totaling the match intensity values in all of the time segments of the streaming composite media file to obtain a match weight value; and
dividing the match weight value by the number of time segments into which the streaming composite media file is divided to obtain a match density value, the match density value being comparable against a match density value obtained from a different streaming composite media file relative to the same sought-after one or more search words, wherein a comparatively higher match density value indicates a greater relevance to the sought-after one or more search words than a different streaming composite media file with a lower match density value.

2. The method according to claim 1, wherein determining whether or not any of the one or more sought-after search words are present in the streaming composite media file comprises determining whether or not any of the one or more sought-after search words are present in any of the plurality of component media streams on a time segment-by-time segment basis, wherein the plurality of component streaming media files includes a mix of data formats including one or more of video, audio, synchronized video and audio, and live computer screen capture streams.

3. The method according to claim 2, wherein assigning a significance value corresponding to each match in a given time segment comprises assigning a significance value to each match in a given time segment based on a combination of 1) a closeness of the match between the one or more sought-after search words and the one or more search words determined to be present in that time segment, and 2) in which component media stream each one or more search word is found.

4. The method according to claim 3, wherein significance values are determined using a mathematical weighting system which uses a relatively high weighting factor for an exact match in the same order between the one or more sought-after search words and the one or more search words found in a given time segment; a relatively intermediate weighting factor if all search words match but not in the same order; and a variable, relatively low weighting factor if only some of the sought-after search words match,
wherein the mathematical weighting system additionally:
1) uses weighting factors depending on the type of component media stream in which each one or more search word is found, based on an expectation that search word matches in some component media streams are more indicative of relevance than matches in other component media streams; and
2) uses weighting factors higher than the weighting factor for an exact match for search word matches when the sought-after search words are present in a static part of the at least one streaming composite media file, including in a title of the at least one streaming composite media file and in a title of a continually displayed document or presentation slide in one of the component media streams.

5. The method of claim 1, further comprising generating searchable dynamic text characterizations or descriptions of the content of each component media stream corresponding in time to each respective component media stream.

6. A method of searching for one or more sought-after search words in a plurality of streaming composite media files each comprising a plurality of component media streams, wherein at least some of the component media streams have different data formats from each other, the method comprising:
dividing each streaming composite media files into a plurality of time segments of equal length;
determining whether or not any of the sought-after search words are present in the streaming composite media file on a time segment-by-time segment basis;
in a time segment where one or more of the sought-after search words are present, assigning a significance value to each match in that time segment based on a closeness of the match between the one or more sought-after search words and the corresponding one or more search words located in that time segment;
totaling the significance values in each respective time segment of each streaming composite media file to obtain a match intensity value for that time segment;
sorting pair values of [match intensity, match location] in descending order of match intensity, wherein match location is specified in terms of an Nth streaming composite media file and the time segment in that streaming composite media file corresponding to that match intensity, and wherein a higher match intensity value is indicative of a comparatively greater relevance to the sought-after search words in the corresponding time segment.

7. A method of searching for one or more sought-after search words in a plurality of streaming composite media files, each comprising a plurality of component media streams, wherein at least some of the component media streams have different data formats from each other, the method comprising:
dividing the streaming composite media files into a plurality of time segments of equal length;
determining whether or not any of the sought-after search words are present in each streaming composite media file on a time segment-by-time segment basis;
in a time segment where one or more of the sought-after search words are present, assigning a significance value to each search word match in that time segment based at least partly on a closeness of the match between the one or more sought-after search words and the corresponding one or more search words located in that time segment;
totaling the significance values in each respective time segment of the streaming composite media file to obtain a match intensity value for that time segment;
totaling the match intensity values for all of the time segments of the streaming composite media file to obtain a match weight value for that streaming composite media file;
dividing the match weight value by the number of time segments into which the streaming composite media file is divided to obtain a match density value, the match density value being comparable against a match density value obtained from a different one of the streaming composite media files relative to the same sought-after one or more search words, such that a comparatively higher match density value indicates a greater relevance to the sought-after one or more search words than a different streaming composite media file with a lower match density value;
storing the streaming composite media files having non-zero match density values in a separate set MATCHES; and
sorting the streaming composite media files in set MATCHES by match intensities to obtain an ordered set of (Match Intensity, Location), where Location corresponds to a unique combination of one of the streaming composite media files in MATCHES and a time segment therein.

8. The method according to claim 7, wherein determining whether or not any of the one or more sought-after search words are present in each streaming composite media file comprises determining whether or not any of the one or more sought-after search words are present in any of the plurality of component media streams constituting that streaming composite media file on a time segment-by-time segment basis, wherein the plurality of component streaming media files includes a mix of data formats including one or more of video, audio, synchronized video and audio, and live computer screen capture streams.

9. The method according to claim 8, wherein assigning a significance value corresponding to each match in a given time segment comprises assigning a significance value to each match in a given time segment based on a combination of 1) a closeness of the match between the one or more sought-after search words and the one or more search words determined to be present in that time segment, and 2) in which component media stream each one or more search word is found.

10. The method according to claim 9, wherein significance values are determined using a mathematical weighting system which uses a relatively high weighting factor for an exact match in the same order between the one or more sought-after search words and the one or more search words found in a given time segment; a relatively intermediate weighting factor if all search words match but not in the same order; and a variable, relatively low weighting factor if only some of the sought-after search words match,
wherein the mathematical weighting system additionally:
1) uses weighting factors depending on the type of component media stream in which each one or more search word is found, based on an expectation that search word matches in some component media streams are more indicative of relevance than matches in other component media streams; and
2) uses weighting factors higher than the weighting factor for an exact match for search word matches when the sought-after search words are present in a static part of the at least one streaming composite media file, including in a title of the at least one streaming composite media file and in a title of a continually displayed document or presentation slide in one of the component media streams.

11. The method of claim 7, further comprising generating dynamic text characterizations or descriptions of the content of each component media stream corresponding in time to each respective component media stream.
